(19) United States
(12) Patent Application Publication
(10) Pub. No.: US 2023/0339147 A1
(43) Pub. Date: Oct. 26, 2023

(54) AUTOCLAVE

(71) Applicant: NORTHSWAN ENGINEERING (PTY) LTD., Boksburg (ZA)

(72) Inventor: Warren John NORTHING, Benoni (ZA)

(21) Appl. No.: 18/303,716

(22) Filed: Apr. 20, 2023

(30) Foreign Application Priority Data
Apr. 21, 2022 (ZA) 2022/04456

(51) Int. Cl. B29C 35/02; F27B 17/00; F27D 7/04

(52) U.S. Cl. CPC B29C 35/0227; F27B 17/0083; F27D 7/04; F27D 2007/045

(57) ABSTRACT

The invention relates to an industrial autoclave used for curing rubber. The autoclave includes a hollow outer body for receiving a product. It also includes a pair of oil-based heat exchangers which are disposed in passageways defined by a pair of ducts. The heat exchangers are connected in parallel to one another in fluid flow communication to a supply of heated oil. Each heat exchanger includes a plurality of serially interconnected, parallel finned radiators which allow passage of the oil therethrough facilitating heat transfer to air passing over the radiators. A fan ensures air circulation. This autoclave is a non-pressurized system with very little wear properties, no risk of fire, no need for a condensate tank and no water treatment is required. In addition, a considerable saving in terms of power consumption is made when compared to electrical autoclaves.

### CROSS-REFERENCE TO RELATED APPLICATIONS

This application claims the benefit of South African Patent Application No. 2022/04456 filed 21 Apr. 2022, the entire contents of which are incorporated herein by reference in its entirety.

### TECHNICAL FIELD

This invention relates to industrial autoclaves.

### BACKGROUND

An autoclave is a machine used to perform industrial processes requiring elevated temperature and pressure in relation to ambient pressure and/or temperature. For example, some autoclaves are used to sterilize medical equipment before surgical procedures. In the chemical industry, autoclaves are used to cure coatings and vulcanize rubber and for hydrothermal synthesis. Industrial autoclaves are used in industrial applications, especially in the manufacturing of composites.

In respect of industrial autoclaves used for curing purposes, there are presently only three mechanisms used for curing. One mechanism makes use of an electric heating element which heats air in the autoclave which then heats the product/workpiece. A drawback associated with electric autoclaves such as these is that they pose a high fire risk and consume lots of power which increases costs. Another mechanism uses dry steam elements which heat the air, that in turn heats the product in the autoclave. Finally, in an alternative configuration, open steam (or wet steam) is used directly to heat the product in the autoclave. Given the rising cost of electricity, use of steam to heat the air/product would be more cost-effective than powering electrical heating elements. However, the use of steam has its own drawbacks. Due to it being a pressurised system, there are additional costs associated with annual statutory inspections and pressure vessel preparations for these statutory inspections. Furthermore, this configuration requires use of a condensate tank, requires a constant operator and a water treatment system. Also, these machines and their components are subject to greater wear through corrosion (rust).

The present invention aims to alleviate the drawbacks discussed above.

### BRIEF SUMMARY

According to a first aspect of the invention, there is provided an autoclave which includes:
an openable, operatively closed hollow body defining an inner chamber, the hollow body being configured to receive a product within the inner chamber;
a heat exchanger which is at least partially disposed within the hollow body and which is operatively connected in fluid flow communication to a supply of heated, heat transfer liquid, wherein the heat exchanger includes a plurality of interconnected heating elements, each heating element taking the form of a radiator which is configured to allow passage of the heat transfer liquid therethrough thus facilitating heat transfer to air passing over the radiator; and
a fan having an impeller, the fan being mounted to the hollow body and being configured to circulate air within the inner chamber, and specifically over the heating elements of the heat exchanger, in order to heat up the air which, in turn, heats up the product, wherein the heat transfer liquid is oil.

The autoclave may not include a steam generator, boiler or pressure vessel. The heat exchanger may be an oil-based heat exchanger. The heat exchanger may not be a pressure vessel.

Each radiator may have a plurality of longitudinally spaced apart fins which extend substantially for the length of the radiator. The radiators of the heat exchanger may be arranged in alternating, up and down fashion and may be serially interconnected such that they are parallel to one another.

Each radiator may have a diameter of 38 mm, end to end. These radiators may be joined one to another using a 180-degree elbow rolled without kinks and welded one element to another. The 180-degree bends may space the radiators 76 mm apart (or more). The heat exchangers may take a minimum of 10 litres of oil or more.

The autoclave may include a heater which is configured to heat the heat transfer liquid and a pump, both of which are connected to the heat exchanger in a closed loop such that the pump is configured continuously to circulate the heat transfer liquid through the heat exchanger.

The autoclave may include a pair of heat exchangers. The pair of heat exchangers may be connected in parallel to the pump by way of a pair of manifolds. The pair of manifolds may include a reducing inlet manifold and a diffusing outlet manifold.

The heat exchangers may be disposed in a pair of longitudinally extending passageways defined by ducts which are in flow communication with a fan outlet at one end and with the inner chamber at the other end.

The autoclave may include a programmable logic controller (PLC) which is configured to control operation of the heater, pump and fan. The heat exchanger may include at least twenty radiators. Preferably, the heat exchanger includes at least 30 radiators. Each manifold may include two legs, each leg comprising three connected segments, each segment having a reduced diameter compared to the adjoining segment. The diameter of each segment may be halved compared to that of the adjoining segment.

The fan may be externally mounted to a distal, rear end of the hollow body. The manifolds may pass through the hollow body.

### BRIEF DESCRIPTION OF DRAWINGS

The invention will now be further described, by way of example, with reference to the accompanying drawings. Please note that a front door, circulation pump, liquid burner/heater and controller have been omitted from the drawings although these components from part of the invention.

In the drawings:

FIG. 1 shows a three-dimensional view of an autoclave in accordance with the invention.

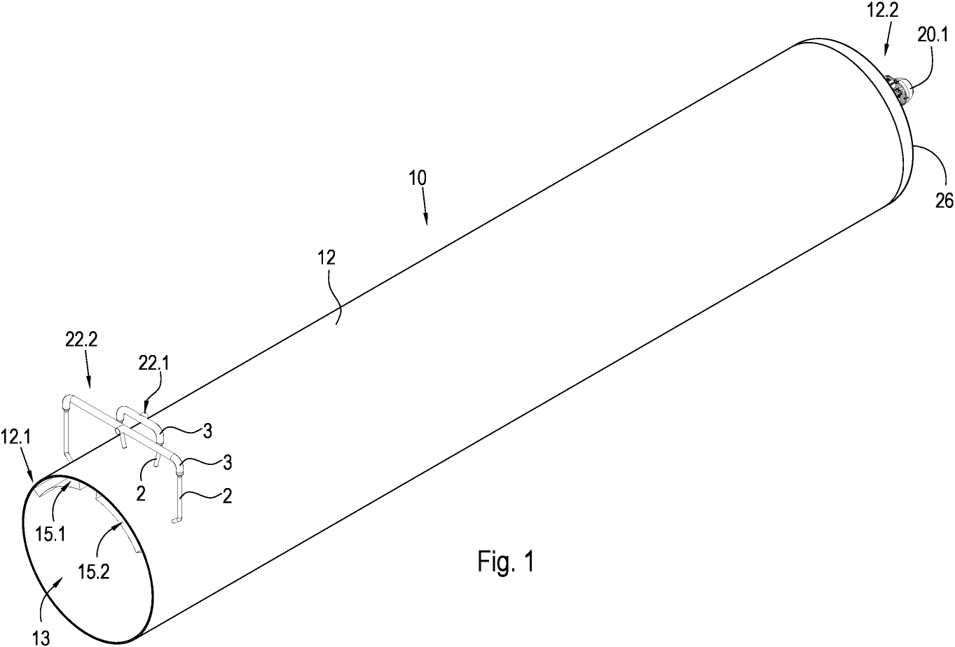

FIG. 2 shows a front, end view of the autoclave.

FIG. 3 shows another three-dimensional view of the autoclave absent of a hollow outer body or shell.

FIG. 4 shows a longitudinal cross-sectional view of the autoclave of FIG. 2 taken along lines IV-IV.

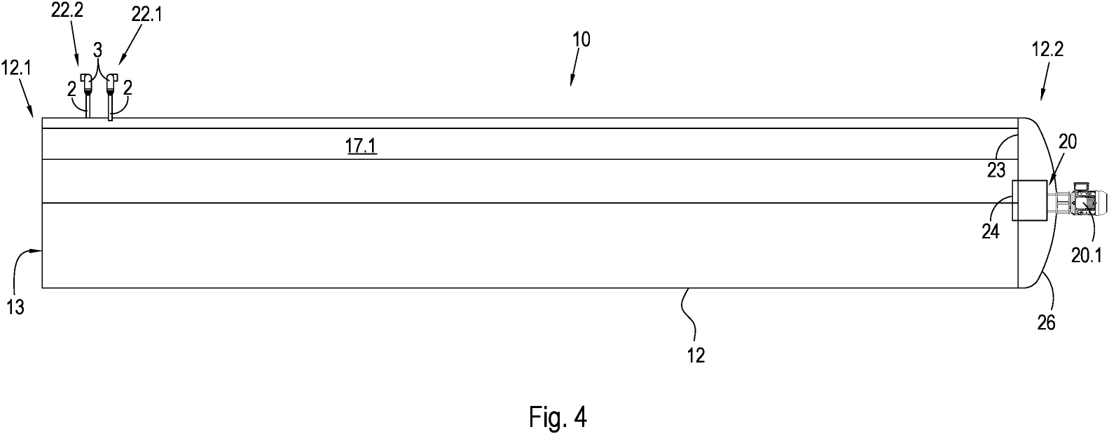

FIG. 5 shows a longitudinal cross-sectional view of the autoclave of FIG. 2 taken along lines V-V.

### DETAILED DESCRIPTION

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof. In the context of this specification, the phrase “pressure vessel” should be understood to have the meaning prescribed by statute.

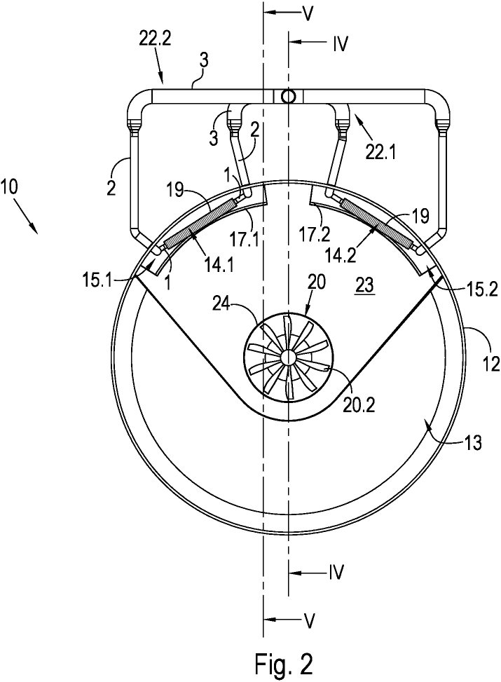

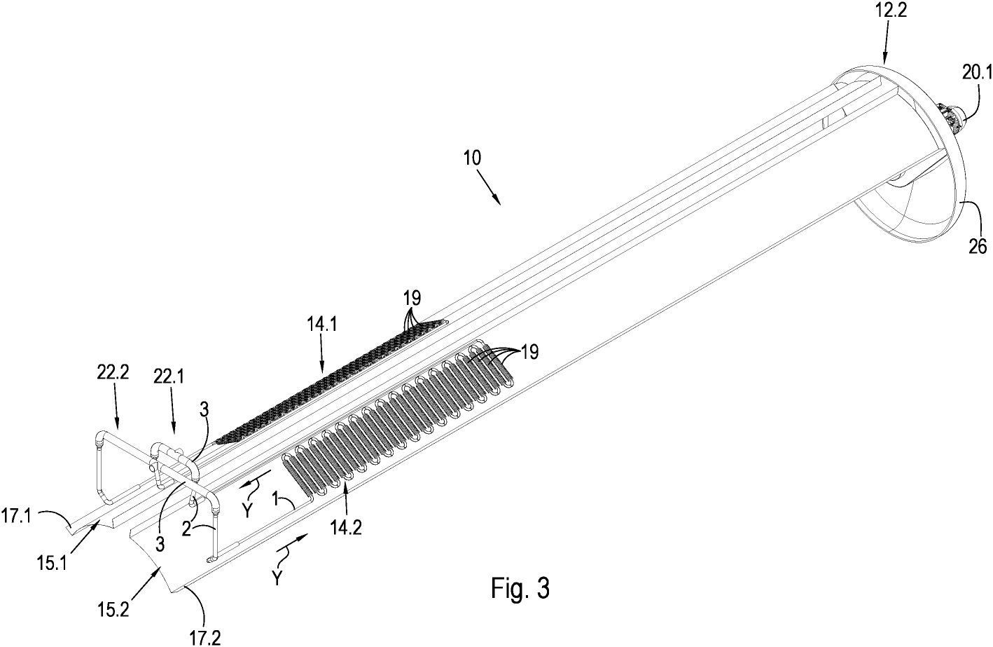

In the Figures, reference numeral 10 refers generally to an industrial autoclave used for curing products such as rubber in industrial processes e.g. for the retreading of tyres. To this end, the autoclave 10 includes an openable, operatively closed hollow outer body 12 or shell in the form of a circular cylinder or tube which defines an inner chamber 13 for receiving a product or workpiece (not shown). A rear end 12.2 of the hollow body 12 terminates in a convexly curved dome 26 whilst a front end 12.1 is operatively closed by a door (not shown). As can best be seen in FIGS. 2 and 3, the autoclave 10 further includes a pair of oil-based heat exchangers 14.1, 14.2 which are disposed in passageways 15.1, 15.2 defined by a pair of longitudinally extending, angularly spaced apart ducts 17.1, 17.2 provided in the inner chamber 13. The pair of heat exchangers 14.1, 14.2 are operatively connected in parallel to one another in fluid flow communication to a supply of heat transfer liquid in the form of heated oil (not shown).

To this end, the autoclave 10 includes a conventional oil burner or heater (not shown) and a circulation pump (not shown) which is configured to circulate the heated oil through the pair of heat exchangers 14.1, 14.2. The circulation pump is connected in a closed loop to the two heat exchangers 14.1, 14.2 to form a closed system and is configured to circulate the heated oil through heating elements of the respective heat exchangers 14. Each heat exchanger 14 includes a plurality of serially interconnected, parallel heating elements in the form of finned radiators 19 which are configured to allow passage of the oil therethrough facilitating heat transfer to air passing over the finned radiators 19.

The autoclave 10 also includes a variable pitch electric fan 20 which is configured to circulate air within the inner chamber 13, along the passageways 15 defined by the ducts 17 and over the heat exchangers 14, in order to heat up the air which, in turn, heats up the product. A fan motor 20.1 is externally mounted to the rear end 12.2 of the hollow body 12 such that an impeller 20.2 of the fan 20 is centrally disposed in the inner chamber 13 as can best be seen in FIG. 2. Although this has not been clearly illustrated in the Figures, it will be appreciated that to increase the surface area of the heating elements, in order to maximise radiator-to-air heat transfer, longitudinally spaced fins, which protrude outwardly, extend for the length of each radiator 19.

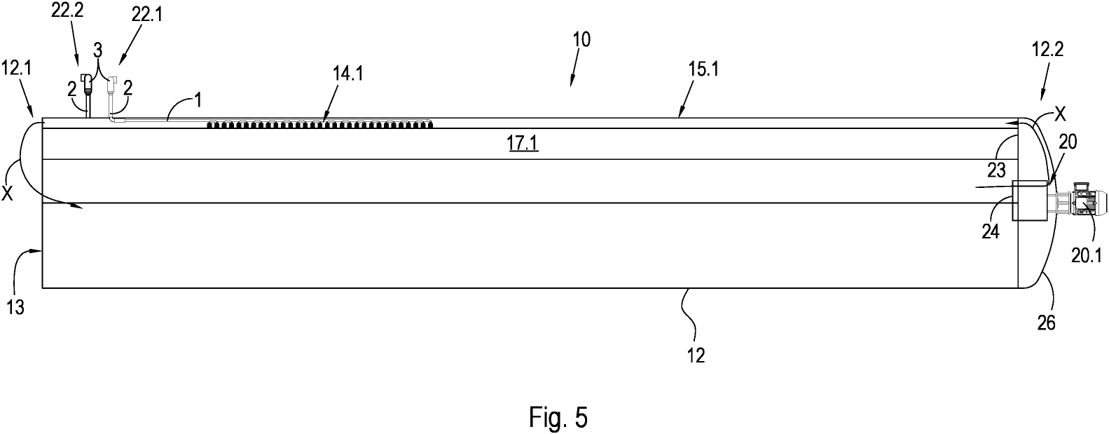

The pair of heat exchangers 14 are connected in parallel to the circulation pump by way of a pair of manifolds 22 provided toward the front end 12.1. The pair comprises a reducing inlet manifold 22.2 and a diffusing outlet manifold 22.1 which pass through the hollow body 12. As can be seen in FIGS. 2 and 3, the heat exchangers 14 are disposed in the longitudinally extending passageways 15 defined by the ducts 17. The heat exchangers 14 extend lengthwise toward the rear end 12.2, with the radiators 19 being arranged in alternating, up and down fashion. Accordingly, the oil flows in the direction indicated by arrows Y in FIG. 3. The passageways 15 are in flow communication with an outlet of the fan 20 proximate the rear end 12.2 and with the inner chamber 13 at the opposite front end 12.1. Arrows X in FIG. 5 indicate airflow direction inside the autoclave 10 as a result of circulation created by the fan 20.

The fan 20 is peripherally enclosed by a shroud 24 defining an axially inner inlet through which air is sucked through the fan 20 and the axially outer outlet which leads into the passageways 15 defined by the ducts 17. Cowling 23 connected to the rear end 12.2 and inner periphery of the hollow body 12 connects the fan outlet in flow communication to the passageways by encircling the shroud 24 and diverges upwards toward to the ducts 17 creating a passage for air to pass into the passageways 15 defined by the ducts 17.

The autoclave 10 also includes at least one programmable logic controller (PLC) (not shown) which is configured to control operation of the heater, pump and fan 20 thereby controlling curing cycles. Each heat exchanger 14 includes at least 30 radiators, preferably 31 radiators arranged in parallel. The reducing inlet manifold 22.2 includes two legs, each leg comprising three connected pipe segments 3, 2, 1 arranged consecutively in a downstream direction. Each downstream segment has a reduced diameter compared to the adjoining upstream segment. The diameter of each downstream segment is halved compared to the adjoining upstream segment. Similarly, the diffusing outlet manifold 22.1 has two legs, each with the same pipe segments which diffuse in the reverse order 1, 2, 3 and magnitude in a downstream direction.

Each leg of the manifold 22 starts off with a 2 inch (50 mm) segment 3 reduced to a 1 inch (25 mm) segment 2 which is further reduced again to a ½ inch segment 1 leading into the heating elements.

The oil-based heat exchangers run at a temperature of 300° C. The PLC handles cure temperature cycles ranging from 10 degree C to 180° C., stepped cycles or straight through curing cycles. The oil used to heat the elements in the autoclave heats the air in the autoclave, which in turn heats the product in the autoclave. There is no pressure in the finned radiators other than the circulating oil pump generated flow pressure.

Due to the fact that the heat exchangers 14 are oil-based, the autoclave 10 does not include a steam generator, boiler or pressure vessel. Instead, the thermal oil heater or burner heats the oil in a non-pressurised way. Furthermore, the heat exchangers themselves are not pressure vessels. The autoclave 10 in accordance with the invention has the advantage of low maintenance costs because there is no need to replace the oil, no maintenance due to rust and wear as with a steam powered autoclave and no requirement for employment of a permanent operator. Due to the fact that it does not include a pressure vessel, the need for compliance with statutory regulation and inspection is obviated and the cost thereof avoided.

Furthermore, the Applicant believes that the autoclave 10 is an improvement upon existing technology and techniques because of the advantages mentioned above and because it is a non-pressurized system with very little wear properties, no risk of fire, no need for a condensate tank and no water treatment is required. In addition, use of the autoclave 10 in accordance with the invention results in a considerable saving in terms of power consumption when compared to an electrical autoclave. This translates into a significant cost saving in terms of maximum demand and overall consumption.

1. An autoclave which includes:
an openable, operatively closed hollow body defining an inner chamber, the hollow body being configured to receive a product within the inner chamber;
a heat exchanger which is at least partially disposed within the hollow body and which is operatively connected in fluid flow communication to a supply of heated, heat transfer liquid, wherein the heat exchanger includes a plurality of interconnected heating elements, each heating element taking the form of a radiator which is configured to allow passage of the heat transfer liquid therethrough thus facilitating heat transfer to air passing over the radiator; and
a fan having an impeller, the fan being mounted to the hollow body and being configured to circulate air within the inner chamber, and specifically over the heating elements of the heat exchanger, in order to heat up the air which, in turn, heats up the product, wherein the heat transfer liquid is oil.

2. The autoclave as claimed in claim 1, which does not include a steam generator, boiler or pressure vessel and wherein the heat exchanger is an oil-based heat exchanger.

3. The autoclave as claimed in claim 2, wherein the heat exchanger is not a pressure vessel.

4. The autoclave as claimed in claim 1, wherein each radiator has a plurality of longitudinally spaced apart fins which extend substantially for the length of the radiator.

5. The autoclave as claimed in claim 4, wherein the radiators of the heat exchanger are arranged in alternating, up and down fashion and are serially interconnected such that they are parallel to one another.

6. The autoclave as claimed in claim 4, which includes a heater which is configured to heat the heat transfer liquid and a pump, both of which are connected to the heat exchanger in a closed loop such that the pump is configured continuously to circulate the heat transfer liquid through the heat exchanger.

7. The autoclave as claimed in claim 6, which includes a pair of heat exchangers, wherein the pair of heat exchangers are connected in parallel to the pump by way of a pair of manifolds.

8. The autoclave as claimed in claim 7, wherein the pair of manifolds include a reducing inlet manifold and a diffusing outlet manifold.

9. The autoclave as claimed in claim 7, wherein the heat exchangers are disposed in a pair of longitudinally extending passageways defined by ducts which are in flow communication with a fan outlet at one end and with the inner chamber at the other end.

10. The autoclave as claimed in claim 6, which includes a programmable logic controller which is configured to control operation of the heater, pump and fan.

11. The autoclave as claimed in claim 1, wherein the heat exchanger includes at least twenty radiators.

12. The autoclave as claimed in claim 11, wherein the heat exchanger includes at least 30 radiators.

13. The autoclave as claimed in claim 7, wherein each manifold includes two legs, each leg comprising three connected segments, each segment having a reduced diameter compared to the adjoining segment.

14. The autoclave as claimed in claim 13, wherein the diameter of each segment is halved compared to that of the adjoining segment.

15. The autoclave as claimed in claim 1, wherein the fan is externally mounted to a distal end of the hollow body.

16. The autoclave as claimed in claim 13, wherein the manifolds pass through the hollow body.
